(19) United States
(12) Patent Application Publication
(10) Pub. No.: US 2022/0100988 A1
(43) Pub. Date: Mar. 31, 2022

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: Takahisa Yamamoto, Kanagawa (JP); Hiroshi Sato, Kanagawa (JP)

(21) Appl. No.: 17/466,753

(22) Filed: Sep. 3, 2021

(30) Foreign Application Priority Data
Sep. 25, 2020 (JP) 2020-161333
May 31, 2021 (JP) 2021-090733

(51) Int. Cl. G06K 9/00; G06K 9/62; G06N 3/08; G06N 3/04

(52) U.S. Cl. CPC G06K 9/00288; G06K 9/00268; G06N 3/0454; G06N 3/08; G06K 9/6232

(57) ABSTRACT

An information processing apparatus configured to determine whether a person in one of two images and a person in the other image are the same person by using a trained model configured to output a feature unique to each person on an image includes an acquisition unit configured to acquire a first feature of a first person in a first image and a second feature of a second person in a second image by using the trained model and an output unit configured to output a first focused region map indicating a correlation between a feature in the first image and a feature in the second image for each region of the first image based on the acquired first feature and the acquired second feature.

### BACKGROUND

### Field of the Disclosure

The present disclosure relates to an image recognition technique using a hierarchical neural network.

### Description of the Related Art

There is a recently developed image recognition technique of extracting useful information from images using a hierarchical neural network and performing some determination (discrimination) based on it. A Computer Vision and Pattern Recognition (CVPR) 2016 paper, Bolei Zhou, Aditya Khosla, Agata Lapedriza, Aude Oliva, Antonio Torralba, Learning Deep Features for Discriminative Localization, discusses visualization of a region as a focused region, which is a basis for determination of classification of an input image, to make an attempt to visualize a basis for determination through a hierarchical neural network.

In performing a task of determining whether two face images are of the same person or of different persons using a hierarchical neural network, the method discussed in the above paper cannot identify a region of an input image which is a basis for its determination.

In addition, the method involves global average pooling (GAP) processing in a last layer of the hierarchical neural network.

### SUMMARY

In light of the above issues, the present disclosure is directed to a technique of identifying a region of an input image as a basis for determination in performing a task of determining whether two face images are of the same person or of different persons. Further, the present disclosure is directed to a technique of identifying a region of an input image as a basis for determination through a hierarchical neural network having a last layer that is not a GAP layer.

According to an aspect of the present disclosure, an information processing apparatus configured to determine whether a person in one of two images and a person in the other image are the same person based on a trained model configured to output a feature unique to each person on an image includes an acquisition unit configured to acquire a first feature of a first person in a first image and a second feature of a second person in a second image based on the trained model and an output unit configured to output a first focused region map indicating a correlation between a feature in the first image and a feature in the second image for each region of the first image based on the acquired first feature and the acquired second feature.

Further features of the present disclosure will become apparent from the following description of exemplary embodiments with reference to the attached drawings.

### BRIEF DESCRIPTION OF THE DRAWINGS

FIG. 1 is a block diagram illustrating an example of a functional configuration of an information processing apparatus.

FIG. 2 is a diagram illustrating an example of a trained model.

FIG. 3 is a diagram illustrating an example of focused region maps.

FIG. 4 is a diagram illustrating an example of focused region maps.

FIG. 5 is a block diagram illustrating an example of a functional configuration of an information processing apparatus.

FIG. 6 is a diagram illustrating an example of a hardware configuration of an information processing apparatus.

FIG. 7 is a flowchart illustrating a process performed by an information processing apparatus.

FIG. 8 is a diagram illustrating an example of a trained model.

### DESCRIPTION OF THE EMBODIMENTS

In exemplary embodiments of the present disclosure, some examples will be described of performing face recognition in one-to-one image comparison. A below-described face recognition technique according to an exemplary embodiment of the present disclosure determines whether two face images are of the same person. In face recognition, recognition accuracy can decrease significantly depending on the camera installation condition. According to an exemplary embodiment of the present disclosure, a focused region as a basis for a comparison result is visualized even in one-to-one image comparison through a hierarchical neural network. Specifically, the focused region as a basis for a determination result is visualized even in determination whether two faces in two images input to a hierarchical neural network performing face recognition are of the same person. Further, a focused region map generated for visualization can be used to increase recognition accuracy. The exemplary embodiments of the present disclosure are directed to a technique of visualizing a basis for determination in a hierarchical neural network performing recognition processing, especially a technique of visualizing a focused region as a basis for a comparison result in one-to-one image comparison through a hierarchical neural network.

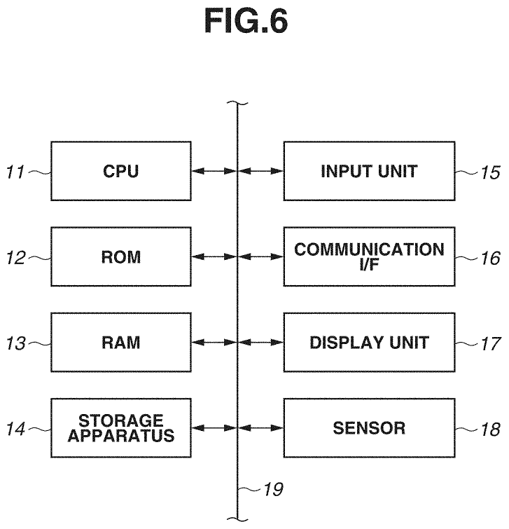

FIG. 6 is a diagram illustrating a hardware configuration of an information processing apparatus 100. A central processing unit (CPU) 11 reads an operating system (OS) or programs stored in a read-only memory (ROM) 12 or a storage apparatus 14, runs the read OS or programs, controls components connected to a system bus 19, and performs calculation and logical determination in various types of processing using a RAM 13 as a work memory. The processing performed by the CPU 11 includes information processing according to one or more exemplary embodiments. The storage apparatus 14 is a hard disk drive or an external storage apparatus and stores programs for information processing according to one or more exemplary embodiments and various types of data. An input unit 15 is an image capturing apparatus such as a camera and is an input device such as buttons, a keyboard, and a touch panel for inputting user instructions. The storage apparatus 14 is connected to the system bus 19 via an interface such as a Serial Advanced Technology Attachment (SATA) interface, and the input unit 15 is connected to the system bus 19 via a serial bus such as a universal serial bus (USB). Detailed description thereof will be omitted. A communication interface (communication 1/F) 16 communicates with an external device in wireless communication. A display unit 17 is a display. A sensor 18 is an image sensor or a range sensor.

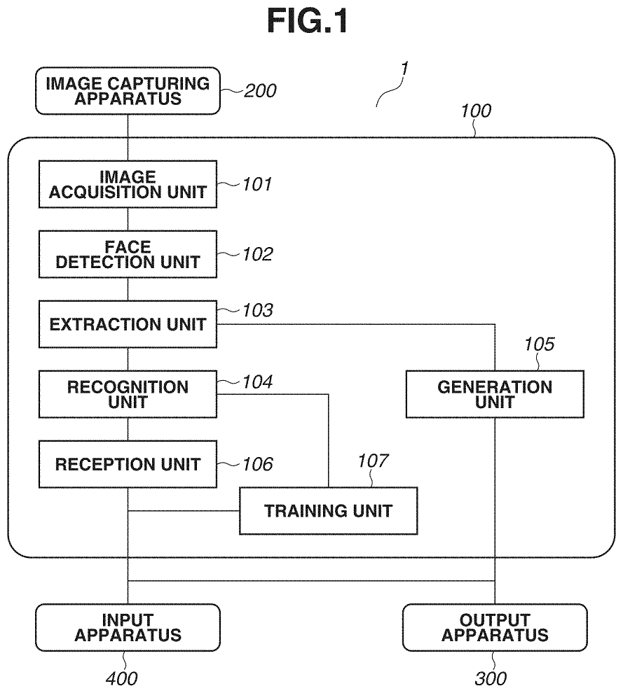

FIG. 1 is a block diagram illustrating a functional configuration of the information processing apparatus 100. An information processing system 1 includes the information processing apparatus 100, an image capturing apparatus 200, an output apparatus 300, and an input apparatus 400. The information processing apparatus 100 is configured to determinate whether two face images are of the same person. The information processing apparatus 100 employs a method of visualizing a focused region in face recognition according to the present exemplary embodiment. In one or more embodiments, the information processing apparatus 100 has the functionality of the image capturing apparatus 200 and the output apparatus 300. The output apparatus 300 displays a generated focused region map and a result of recognition of two images in an image. The input apparatus 400 is an apparatus that receives user input.

An image acquisition unit 101 acquires an image captured by the image capturing apparatus 200 or an image stored in an external storage apparatus. The image capturing apparatus 200 is an apparatus that feeds image data as a face recognition target. In one or more embodiments, the image capturing apparatus 200 is physically distant from the information processing apparatus 100, and acquires image data over a network.

A face detection unit 102 detects the face of a person on an image acquired by the image acquisition unit 101 (detection of a partial image of a face region). The face detection may be performed by a publicly-known method for face detection. For example, a method is of extracting the shape corresponding to an element of a face region, such as the nose, the mouth, or the eyes, estimating the face size based on the sizes of both eyes and the distance between the eyes, and determining to be a face region a region defined based on the estimated size with the position corresponding to the center of the nose as a reference. Alternatively, the face detection is performed by a face detection method using a hierarchical neural network (a trained model for face detection). In this method, a trained model receives face images of a person input prepared in advance to learn features of the face images of the person. The face detection unit 102 inputs an image to the trained model for face detection to detect a partial image containing a face region of the person in the input image. The image containing the detected face region is normalized to a predetermined size by a predetermined method, and the normalized image is output as a face region image to an extraction unit 103.

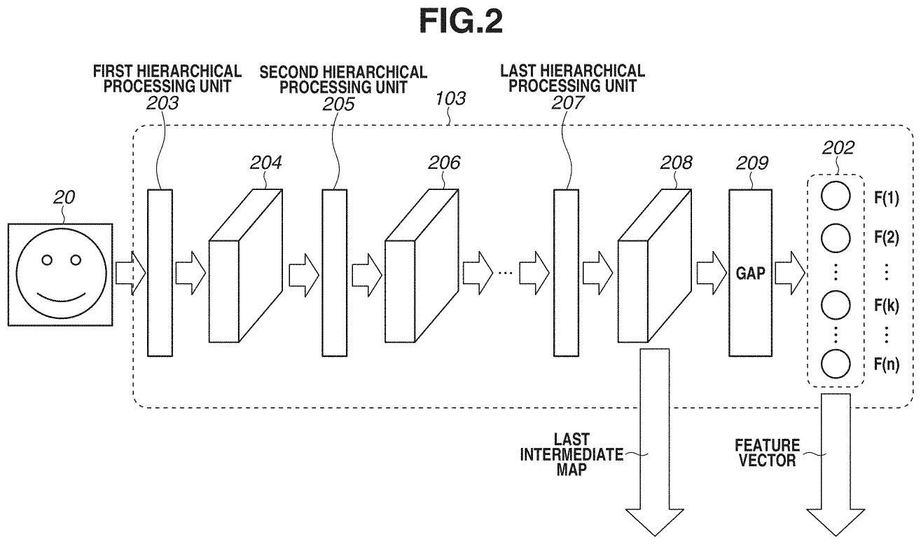

The extraction unit 103 extracts a feature vector and an intermediate feature map from each detected face image based on the trained model to output a feature vector unique to each person on an image. Specifically, the extraction unit 103 extracts a feature vector and an intermediate feature map from the face region image output from the face detection unit 102. The extraction unit 103 performs extraction processing to extract information to recognize an individual from. The extraction unit 103 will be described below with reference to FIG. 2. The extraction processing is performed on a first image and a second image each. The first image is a recognition target, and the second image is a comparison target. As a result, the extraction processing outputs a first feature vector indicating a feature of a first person in the first image and a second feature vector about a second person in the second image. Further, a first intermediate feature map is acquired from the first image, and a second intermediate feature map is acquired from the second image.

FIG. 2 is a schematic diagram illustrating a process in the extraction unit 103. A face region image 20 is a face image output by the face detection unit 102 and normalized to a predetermined size by the face detection unit 102. The extraction unit 103 extracts an intermediate feature map and a feature vector using a method through a convolutional neural networks (CNN), a type of a hierarchical neural network. The CNN is a trained model that extracts abstracted information from an input image by repeating a process including convolutional processing, non-linear processing, and pooling processing on an input image. A unit of processing consisting of convolutional processing, non-linear processing, and pooling processing is often referred to as a hierarchical layer. Various publicly-known methods for non-linear processing include a Rectified Linear Unit (ReLU) method to be used. Further, various publicly-known methods for pooling processing include a maximum value pooling (max pooling) method to be used.

The CNN (a trained model) of the extraction unit 103 has been trained to extract information (a feature vector unique to each person) for recognizing the person on a face image. The term “training” means adjusting a large number of parameters for the CNN processing of the extraction unit 103. Thus, information for recognizing the person on an input image is extracted through the parameters adjusted by training.

The extracted information for recognizing a person is referred to as “feature vector” (or also referred to as “feature value”) and is output from the extraction unit 103. The training performed in advance may employ a publicly-known method. For example, a method is of defining a softmax loss function, and adjusting CNN parameters by backpropagation to reduce the value of the loss function.

A first hierarchical processing unit 203 performs convolutional processing, non-linear processing, and pooling processing on an input image. The first hierarchical processing unit 203 outputs a first intermediate map 204. The first intermediate map 204 is input to a second hierarchical processing unit 205. The second hierarchical processing unit 205 performs convolutional processing, non-linear processing, and pooling processing, as in the first hierarchical processing unit 203, and outputs a second intermediate map 206. The extraction unit 103 repeats the above-described hierarchical processing on the input image to calculate a feature vector from which an individual is recognizable.

A last hierarchical processing unit 207 performs convolutional processing on the data input from the previous hierarchical layer and outputs a last intermediate map 208. A global average pooling (GAP) processing unit 209 performs GAP processing. GAP processing is a pooling method of outputting the mean of all the element values of a feature plane. Thus, the number of feature planes of the last intermediate map 208 as a GAP target is equal to the number of dimensions of a feature vector output. GAP processing is expressed by formula (1) below. In formula (1), f(x, y, k) is an element value of the position (x, y) of the kth feature plane of the last intermediate map 208. Further, the calculated feature vector is indicated by F, and the kth element (F(k)) of the feature vector F is a calculated mean value (M is the size (the number of pixels) of the feature plane) of all the elements of the kth feature plane of the last intermediate map 208. Further, k is an index specifying a number for the feature plane. For example, n feature planes of the last intermediate map 208 results in n dimensions of the feature vector output through GAP processing.

$$\begin{matrix}[ Formula 1 ] & \\ F ( k ) = \frac{1}{M} {\sum }_{x} {\sum }_{y} f ( x , y , k ) . & formula ( 1 )\end{matrix}$$

A feature vector 202 is calculated by GAP processing, and the number of dimensions of the feature vector 202 is equal to the number of feature planes of the last intermediate map 208 as a GAP calculation source, as illustrated in formula (1). Further, as described above, the feature vector 202 is information for recognizing a person in the input face image. The extraction unit 103 outputs the feature vector 202 calculated using formula (1) and outputs the last intermediate map 208 (f(x, y, k)) as the GAP calculation source.

With two feature vectors sent from the extraction unit 103, a recognition unit 104 determinate whether the faces in two images as the sources for the two feature vectors are of the same person. Specifically, the recognition unit 104 calculates the cosine similarity between the two feature vectors, and with a calculated cosine similarity higher than a predetermined threshold value, the recognition unit 104 determines that the faces in the original two images are of the same person. On the other hand, with a calculated cosine similarity lower than the predetermined threshold value, the recognition unit 104 determines that the faces in the original two images are not of the same person.

For example, the extraction unit 103 receives two face region images (referred to as “face region images p and q”) input from the face detection unit 102 to calculate a feature vector Fp (first feature vector) corresponding to the face region image p and a feature vector Fq (second feature vector) corresponding to the face region image q. The recognition unit 104 calculates the cosine similarity (expressed as “cos_similarity (p, q)”) between the first and second feature vectors using formula (2) below. In formula (2), a subscript “i” discriminates between the processing on the first image p and the processing on the second image q.

$$\begin{matrix}[ Formula 2 ] & \\ cos\_similarity ( p , q ) = {\sum }_{k = 1}^{n} \{ {\tilde{F}}_{p} ( k ) \times {\tilde{F}}_{q} ( k ) \} , & formula ( 2 ) \\ [ Formula 3 ] & \\ {\tilde{F}}_{i} ( k ) = \frac{{F}_{i} ( k )}{{N}_{i}} , {N}_{i} = \sqrt{{\sum }_{k = 1}^{n} {{F}_{i} ( k )}^{2}} ( i = p , q ) . & formula ( 3 )\end{matrix}$$

The recognition unit 104, as described above, compares the cosine similarity and the threshold value, determines whether the face in the first image p and the face in the second image q are of the same person, and outputs a result of the determination (about whether the faces are of the same person) as a recognition result.

A generation unit 105 calculates a focused region map as described below. First, the first feature vector corresponding to the first image p and the second feature vector corresponding to the second image q are expressed by formula (4) obtained by rewriting formula (1).

$$\begin{matrix}[ Formula 4 ] & \\ {F}_{i} ( k ) = \frac{1}{M} {\sum }_{x} {\sum }_{y} {f}_{i} ( x , y , k ) ( i = p , q ) . & formula ( 4 )\end{matrix}$$

The generation unit 105 calculates a focused region map G(x, y) based on the last intermediate map f and the feature vector F output from the extraction unit 103. Formula (6-1) is a formula for calculating a first focused region map for the first image p obtained in comparing the first image p to the second image q. Formula (6-2) is a formula for calculating a second focused region map for the second image q obtained in comparing the second image q to the first image p.

$$\begin{matrix}[ Formula 5 ] & \\ {\tilde{f}}_{i} ( x , y , k ) = \frac{{f}_{i} ( x , y , k ) }{{N}_{i}} ( i = p , q ) & formula ( 5 ) \\ [ Formula 6 ] & \\ {G}_{p} ( x , y ) = \frac{1}{M} {\sum }_{k = 1}^{n} \{ {\tilde{f}}_{p} ( x , y , k ) \times {\tilde{F}}_{q} ( k ) \} . & formula ( 6 \text{-} 1 ) \\ [ Formula 7 ] & \\ q ( x , y ) = \frac{1}{M} {\sum }_{k = 1}^{n} \{ {\tilde{f}}_{q} ( x , y , k ) \times {\tilde{F}}_{p} ( k ) \} . & formula ( 6 \text{-} 2 )\end{matrix}$$

Since N in formula (3) is the square root of the sum of the squares of each element of the feature vector, the feature vector normalized (so that the L2 norm becomes one) is calculated in formula (3) (the calculated feature vector is referred to as “normalized feature vector”). Further, formula (5) is a division of the last intermediate map by the square root of the sum of the squares of the feature vector (this is referred to as “normalized last intermediate map”). The meaning of the focused region map G calculated by formulas (6-1) and (6-2) will be described. First, adding all the regions of the focused region map G and calculating the cosine similarity between the feature vectors Fp and Fq (i.e., formula (2)) are the same. This will be described below.

$$\begin{matrix}[ Formula 8 ] & \\ {\sum }_{x} {\sum }_{y} {G}_{p} ( x , y ) = {\sum }_{x} {\sum }_{y} \frac{1}{M} {\sum }_{k = 1}^{n} \{ {\tilde{f}}_{p} ( x , y , k ) \times {\tilde{F}}_{q} ( k ) \} = {\sum }_{k = 1}^{n} \{ \frac{1}{M} {\sum }_{x} {\sum }_{y} \{ {\tilde{f}}_{p} ( x , y , k ) \times {\tilde{F}}_{q} ( k ) \} \} = {\sum }_{k = 1}^{n} \{ {\tilde{F}}_{p} ( k ) \times {\tilde{F}}_{q} ( k ) \} . & ( formula 7 \text{-} 1 ) \\ [ Formula 9 ] & \\ {\sum }_{x} {\sum }_{y} {G}_{q} ( x , y ) = {\sum }_{x} {\sum }_{y} \frac{1}{M} {\sum }_{k = 1}^{n} \{ {\tilde{f}}_{q} ( x , y , k ) \times {\tilde{F}}_{p} ( k ) \} = {\sum }_{k = 1}^{n} \{ \frac{1}{M} {\sum }_{x} {\sum }_{y} \{ {\tilde{f}}_{q} ( x , y , k ) \times {\tilde{F}}_{p} ( k ) \} \} = {\sum }_{k = 1}^{n} \{ {\tilde{F}}_{q} ( k ) \times {\tilde{F}}_{p} ( k ) \} . & ( formula 7 \text{-} 2 )\end{matrix}$$

It is understood that a value calculated by formula (7-1) and a value calculated by formula (7-2) are the same value and that this is formula (2) of the cosine similarity between the feature vectors Fp and Fq. In other words, formulas (7-1) and (7-2) indicate that the cosine similarity between the feature vectors Fp and Fq is calculated by adding all the regions of the focused region map G.

Adding the pixels of the focused region map G results in the cosine similarity, which means that a greater pixel value of each of the pixels of the focused region map G contributes to the cosine similarity calculation more significantly. In other words, the focused region map G is a map that indicates which pixel (or a region as a set of pixels) is focused in calculating the cosine similarity.

A reception unit 106 receives feedback information about whether a user-input recognition result is correct. The reception unit 106 also receives a user instruction to end. A training unit 107 updates the parameters of the trained model based on the feedback information from the user.

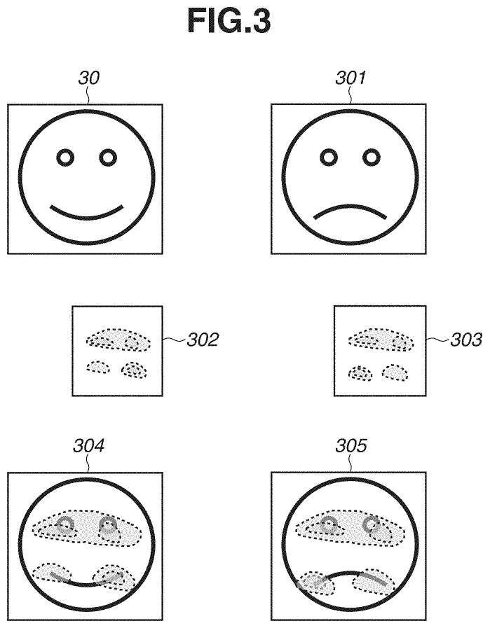

A specific example of the focused region map G will be described. FIG. 3 illustrates a calculation example of focused region maps. An image 30 represents the first image p, and an image 301 represents the second image q. In FIG. 3, the first person in the first image p and the second person in the second image q are the same person (the person will temporarily be referred to as “person P”).

A map 302 represents a first focused region map for the first image p calculated using formula (6-1), and a map 303 represents a second focused region map for the second image q calculated using formula (6-2). The first and second focused region maps are calculated in comparing the first image p and the second image q.

In the feature vector calculation using a hierarchical neural network (trained model), in general, the size of an intermediate map decreases as the processing proceeds (into forward hierarchical layers). Thus, the focused region maps 302 and 303 are smaller in size than the images 30 and 301, respectively. The focused region maps 302 and 303 display dotted contour lines to show the sizes of the pixel values of the map. Display is in colors changed with the size of a pixel value (pixels with greater values are redder whereas pixels with smaller values are bluer) or each region with a pixel value greater than or equal to a threshold value is emphasized.

In FIG. 3, the focused region maps 302 and 303 exhibit similar patterns. This is because the input images are of the same person. In the feature vector calculation using a hierarchical neural network (trained model), information by which an individual is recognized is calculated as a feature vector. As illustrated in FIG. 2, a feature vector is obtained by simply averaging the feature planes of a last intermediate map, which means that the last intermediate map is where information by which an individual is recognized is extracted.

Thus, in the feature vector calculation using a hierarchical neural network (trained model), both the last intermediate map and the feature vector express information by which an individual is recognized. In this case, the last intermediate maps or the feature vectors that are obtained from face images of the same person are expected to be similar to each other. Since a focused region map is obtained by weighted-addition of the last intermediate map of the focused region map using a feature vector of a comparison target image, it is obvious that patterns are similar to each other as a result of comparison of the same person.

A map 304 is the first focused region map 302 superimposed on the first face image 30. The superimposed display is formed in the size of the first focused region map 302 adjusted to the size of the first face image 30. A map 305 is the second focused region map 303 superimposed on the second face image 301. The maps 304 and 305 of the superimposed images indicate that regions around the eyes and the corners of the mouth in the last intermediate maps are mainly focused in calculating the cosine similarity. In other words, the determination result that the input face images 30 and 301 are of the same person is based on information about the regions around the eyes and the corners of the mouth of the person P.

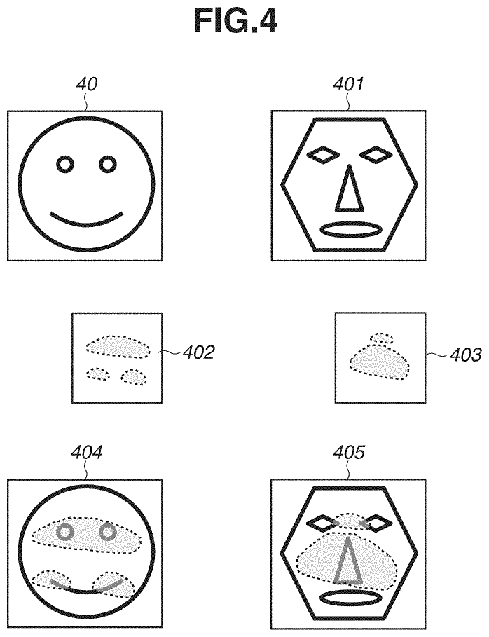

Further, FIG. 4 illustrates another calculation example of focused region maps. An image 40 represents the first image p, and an image 401 represents a second image r (the images 30 and 40 are the same image). The person in the first image p of the image 40 is not the same person as a person in the second image r (the person in the second image r of the image 401 will temporarily be referred to as “person R”).

An image 402 is a first focused region map for the first face image p, and an image 403 is a second focused region map for the second image r. The first and second focused region maps are calculated in comparing the first image p and the second image r.

The first focused region map 402 and the second focused region map 403 exhibit a significantly different pattern from each other. This is because the persons in the two images are not the same person. As described above, in the feature vector calculation using a hierarchical neural network, information by which an individual is recognized is calculated as a last intermediate map or a feature vector. A focused region map is obtained by weighted-addition of the last intermediate map using a feature vector of a comparison target image. Different persons are likely to have significantly different feature vectors and significantly different intermediate feature maps from each other. Apparently, the focused region maps are significantly different from each other since they are obtained by weighted-addition of the intermediate feature maps, which are significantly different from each other, with the feature vectors, which are significantly different from each other.

A map 404 is the first focused region map 402 superimposed on the first face image 40. A map 405 is the second focused region map 403 superimposed on the second face image 401. The map 404 indicates that regions around the eyes and the corners of the mouth in the first image p of the image 40 are focused in calculating information by which the person P as an individual is recognized. On the other hand, the map 405 indicates that a region between the eyes and a region around the center of the face in the second image r of the image 401 are focused in calculating information by which the person R as an individual is recognized. The focused regions differ between the persons P and R.

Further, different target images in comparison with the same input image (the images 30 and 40) result in different focused maps (the maps 302 and 402) provided to the same input image depending on the comparison target image. The same input image has a last intermediate map but has a different focused map obtained by weighted-addition of the same last intermediate map using the feature vector of a different comparison target. Thus, in comparing a pair of face images, each focused region map illustrated in FIGS. 3 and 4 clarifies which regions in the faces are focused as a basis for determination of whether the face images are of the same person.

Further, as described above, adding the pixel values of all the regions of the first or second focused region map results in the cosine similarity of the first or second feature vector. Thus, the focused region maps (the maps 302 and 303) of the same person include regions with great pixel values, whereas the focused region maps (the maps 402 and 403) of different persons are expected to include regions with small pixel values. Thus, for example, with the focused region maps in a heat map form (red represents great pixel values, whereas blue represents small pixel values), the maps 302 and 303 are reddish images, whereas the maps 402 and 403 are bluish images.

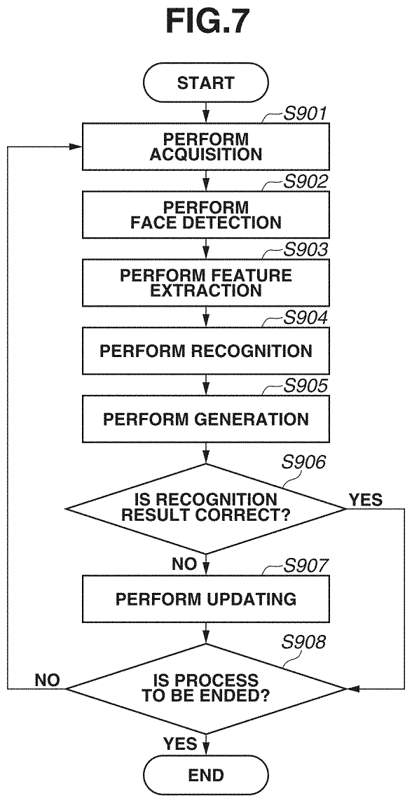

FIG. 7 is a flowchart illustrating a process performed by the information processing apparatus 100, which will be described. The process illustrated in the flowchart in FIG. 7 is performed by the CPU 11 illustrated in FIG. 6, which is a computer, based on computer programs stored in the storage apparatus 14. In one or more embodiments, the information processing apparatus 100 performs some of all the steps illustrated in the flowchart.

In step S901, the image acquisition unit 101 acquires two images captured by the image capturing apparatus 200 or stored in an external storage apparatus. One of the two images as a recognition target image will be referred to as “first image”, whereas the other image as a reference image will be referred to as “second image”. In step S902, the face detection unit 102 detects the faces of persons on the images acquired by the image acquisition unit 101. The face detection unit 102 detects a first partial image in a face region of a first person on the first image. Similarly, the face detection unit 102 detects a second partial image in a face region of a second person on the second image. The first and second images in step S903 and subsequent steps refer to the first and second partial images, respectively. For the first and second images each with nothing but the face of a person, step S902 can be skipped. In step S903, the extraction unit 103 extracts a first intermediate feature map indicating a feature of the first person in the first image based on the trained model configured to output a feature vector unique to each person on an image. Further, the extraction unit 103 extracts a second intermediate feature map indicating a feature of the second person in the second image. Further, the extraction unit 103 extracts a feature vector for each detected face based on the trained model. Details of the processing follow the description above with reference to FIG. 2.

In step S904, the recognition unit 104 determines whether the faces in the two images are of the same person based on the first and second feature vectors. Specifically, the recognition unit 104 determines whether an object in the first image and an object in the second image are the same object based on the first and second feature vectors calculated based on the first and second intermediate feature maps.

In step S905, the generation unit 105 outputs a first focused region map based on the first intermediate feature map and the second feature vector. The first focused region map indicates the correlation between the features in the first and second images for each region of the first image. Similarly, a second focused region map is generated based on the second intermediate feature map and the first feature vector. When the focused region maps are displayed, for example, each correlation is expressed as a score, and different colors are used to discriminate between regions with high scores and regions with low scores. The focused region maps are output to a display apparatus and shown to the user. The second focused region map indicating the correlation between the features in the first and second images for each region of the second image is output based on the first intermediate feature map and the second intermediate feature map. The two focused region maps are simultaneously output for comparison of the two maps, enhancing feedback accuracy as compared with the case of referring to one map.

In step S906, the reception unit 106 determines whether the recognition result is correct based on the user-input feedback information about whether the recognition result in step S905 is correct. If the feedback indicates that the recognition result is correct (YES in step S906), the processing proceeds to step S908. Otherwise (NO in step S906), the processing proceeds to step S907. The user can determine whether the recognition result is correct and the progress of the training of the trained model by checking the focused region maps.

In step S907, the training unit 107 updates the weighted parameters of the trained model based on the input feedback information. In step S908, the reception unit 106 determines whether to continue or end the process. If a user instruction to end is received (YES in step S908), the process ends. The process can be continued for a predetermined length of time, or the recognition processing can be performed on a predetermined number of images. On the other hand, if a user instruction to end is not received (NO in step S908), the processing returns to step S901 to continue the process.

The above description is of a method of calculating a focused region map according to the present exemplary embodiment and the information processing apparatus 100, which employs the method. As described above in the present exemplary embodiment, the focused region maps output in face recognition clarify a basis for determination in face recognition. For example, checking the maps 304 and 305 in FIG. 3 makes it possible to learn the regions focused in face recognition to determine that the two faces are of the same person. Similarly, checking the maps 404 and 405 in FIG. 4 makes it possible to learn the regions focused in face recognition to determine that the two faces are not of the same person.

The clarification of a basis for the determination of a result of face recognition is significantly important for practical use of face recognition. As described above, use of a hierarchical neural network (deep learning) increases the accuracy of face recognition. Without presenting a basis for determination, there remains a doubt about whether “the result is truly reliable”. This doubt can be an obstacle to the practical use of face recognition, but presenting the focused region maps successfully according to the present exemplary embodiment eliminates the doubt, making the face recognition more reliable. Specifically, the face recognition is used reliably with the obstacle to the practical use eliminated.

### MODIFIED EXAMPLE

An example will be described of using focused region maps in recognition processing. The focused region maps calculated in comparing images of the same person have a similar pattern to each other. On the other hand, the focused region maps calculated in comparing images of different persons have a different pattern from each other. Thus, comparing the focused region maps provides information for determining whether two faces in two images are of the same person. The present exemplary embodiment uses the above-described characteristics of the focused region maps to increase the accuracy of face recognition.

The recognition unit 104 receives the first and second focused region maps from the generation unit 105 simultaneously on reception of the first and second feature vectors from the extraction unit 103. The recognition unit 104 calculates a cosine similarity using the feature vectors and calculates a similarity (referred to as “focused region similarity”) using the first and second focused region maps. There are various possible methods of calculating a focused region similarity. For example, there is a method of raster-scanning the pixel values of the focused region maps to obtain one-dimensional vectors (the vectors will be referred to as “focused region visualization vectors”) and take the inner product of two focused region visualization vectors as a focused region similarity. The recognition unit 104 calculates the weighted sum of the calculated cosine similarity and the calculated focused region similarity, and performs threshold value processing on the calculated weighted sum to determine whether the faces in the original two images are of the same person. This method is expected to increase the accuracy of face recognition compared to the determination of a recognition result based on the cosine similarity alone using the feature vectors. As described in detail above in the first exemplary embodiment, the cosine similarity between the feature vectors is obtained by adding the pixels of all the regions of the focused region maps. Specifically, the focused region maps can be considered to be a map indicating a region (pixels in the focused region map) that is focused in calculating the cosine similarity.

A high cosine similarity is expected to indicate a comparison of face images of the same person. However, a high cosine similarity may indicate a comparison of face images of different persons (i.e., false recognition). Among various possible causes, similar illumination conditions of two face images or poor image conditions (low resolution, excessive noise) can result in a high cosine similarity even with face images of different persons. On the contrary, it is possible that the focused region maps have completely different patterns from each other.

Comparison of face images of the same person often shows similar focused region map patterns, as well as a high cosine similarity. Thus, as described above in the present exemplary embodiment, use of the cosine similarity and the focused region similarity together in calculating a recognition result is expected to improve the accuracy of face recognition.

While the recognition unit 104 calculates the focused region similarity by calculating the inner product of the focused region visualization vectors, this is not limiting the method of calculating the focused region similarity. Cosine similarity can be calculated using focused region visualization vectors. Further, a method may be employed of calculating the sum of absolute differences (L1 distance) or the Euclidean distance (L2 distance) between the focused region visualization vectors to take the reciprocal of the calculation result as a focused region similarity.

Further, there are also various possible methods of calculating a recognition result using both cosine similarity and focused region similarity. While the weighted sum of the similarities is used in the above-described case, there are other possible methods such as a method of performing non-linear transformation on the similarities and then performing threshold value processing. A weight to be used in calculating the weighted sum and a method of non-linear transformation can be determined by cross-validation using prepared test data.

A second exemplary embodiment will be described. In the first exemplary embodiment, the example has been described of comparing two images to determine whether the faces in the images are of the same person. In the present exemplary embodiment, an example will be described of a face recognition system of determining which or none of the persons to be recognized registered previously in the system (referred to as “registration face image”) is a person in a face image input in the system. A recognition target image will be referred to as “first image”, and a reference registration face image will be referred to as “second image”.

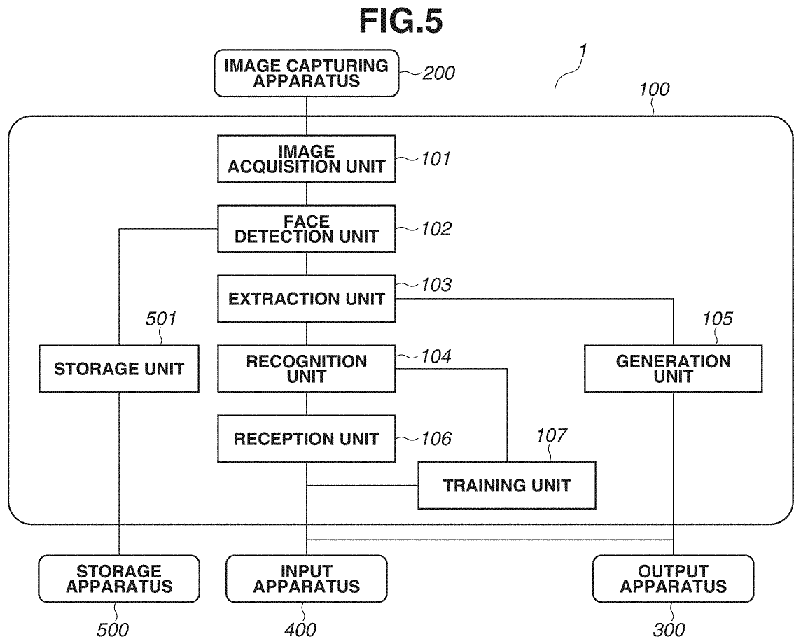

FIG. 5 is a block diagram illustrating a configuration of the information processing system 1 according to the present exemplary embodiment. In FIG. 5, like numbers refer to like components in FIG. 1, and redundant descriptions thereof will be omitted. A storage unit 501 stores feature vectors (referred to as “registration feature vectors”) and last intermediate maps (referred to as “registration last intermediate map”) for registration face images (second images). The registration feature vectors and the registration last intermediate maps are calculated by a method similar to that described above. Specifically, a method is of inputting a registration face image as an input image to a trained model, performing face detection on the input image to detect a face, calculating a feature vector and a registration last intermediate map based on the detected face. The storage unit 501 manages a person identification (person ID) of each registered person in association with the registration feature vector and the registration last intermediate map of the person. The storage unit 501 transmits a stored pair of the registration feature vector and the person ID of the registration person to the recognition unit 104. Further, the storage unit 501 transmits the registration feature vector and the registration last intermediate map of the person to the generation unit 105 based on a recognition result (a result of determination about whether the input face image is one or none of the persons of the person IDs of the registered persons) transmitted from the recognition unit 104.

The recognition unit 104 compares the feature vector (first feature vector) of the first image transmitted from the extraction unit 103 and the registration feature vector (second feature vector) transmitted from the storage unit 501 to calculate the similarity. In the present exemplary embodiment, the cosine similarity between the feature vector of the first image and the registration feature vector is calculated. The recognition unit 104 compares the calculated similarity and a preset threshold value to output a recognition result.

For the storage unit 501 storing a plurality of registration feature vectors, the similarity between a first feature vector calculated from the first image and each of the registration feature vectors is calculated. In this case, the number of similarities to be calculated is equal to the number of registration feature vectors. The recognition unit 104 performs threshold value processing on the highest one of the similarities. Then, the recognition unit 104 outputs the registered person ID associated with the registration feature vector of the highest similarity as a recognition result. If none of the similarities is higher than the threshold value, the recognition unit 104 outputs a result indicating that none of the registered persons correspond to the face. The recognition unit 104 transmits the recognition result also to the storage unit 501.

The generation unit 105 receives the feature vector and the last intermediate map for the first image from the extraction unit 103 and receives the registration feature vector and the registration last intermediate map from the storage unit 501. The generation unit 105 calculates a first or second focused region map based on the received information. A focused region map can be calculated by a method similar to that in the first exemplary embodiment. In the first exemplary embodiment, focused region maps are calculated for two face region images using formulas (6-1) and (6-2). In the present exemplary embodiment, similarly, formulas (6-1) and (6-2) are applied to a pair of the first image (single image) and one second image to calculate first and second focused region maps. Thus, assuming that T sets of registration feature vectors and registration last intermediate maps are transmitted from the storage unit 501, combining the first image and each of the T registration images form T pairs. Formulas (6-1) and (6-2) are applied to each of the T pairs to calculate focused region maps. In this case, T sets of focused region maps are calculated.

It is predetermined how many sets of registration feature vectors and registration last intermediate maps will be transmitted from the storage unit 501 to the generation unit 105. In one or more embodiments, the storage unit 501 sends the registration feature vector and the registration last intermediate map for the registered person ID of the highest similarity calculated by the recognition unit 104. In this case, one pair of focused region maps are calculated. If the focused region maps for all the other registered persons are used in addition to that for the registered person ID of the highest similarity, the registration feature vectors and the registration last intermediate maps for all the registered persons may be transmitted to the generation unit 105.

As described above, a face recognition system that compares an input face image with the corresponding registered face image outputs a focused region map in face recognition, clarifying a basis for determination in face recognition as in the first exemplary embodiment.

Presenting a basis for determination in face recognition using a focused region map as described in the present exemplary embodiment is expected to gain reliability of face recognition, clearing an obstacle to practical use. Further, a face recognition system that compares a registration face image and the first image as described above in the present exemplary embodiment can use a focused region map in recognition processing. In this case, the registration feature vectors and the registration last intermediate maps for all the persons are transmitted to the generation unit 105, and the calculated focused region maps are transmitted to the recognition unit 104. The recognition unit 104 calculates a focused region similarity using a focused region map to use the calculated focused region similarity in recognition.

### MODIFIED EXAMPLE

The storage unit 501 according to the second exemplary embodiment stores registration feature vectors and registration last intermediate maps (second intermediate feature maps). Comparing with storing registration feature vectors with a typical face recognition system, storing registration last intermediate maps in addition to registration feature vectors in the storage unit 501 leads to increase of the resource of the storage unit 501, which results in increase in the cost of a face recognition system. The following is a description of an example of not storing registration last intermediate maps.

In the present modified example, a third focused region map generated for the same registration face image is stored in place of registration last intermediate maps. The amount of data about the focused region maps is one over the number of dimensions of feature vectors as compared with the case of storing the registration last intermediate maps as well. This configuration prevents an increase of the resource of the storage unit 501. Further, the obtained focused region map has higher values in the regions showing a feature of the person, which means that some pixels have higher values. Thus, displaying the focused region map visualizes the regions of the person in the image that are focused in person recognition.

The storage unit 501 in FIG. 5 stores a focused region map (referred to as “third focused region map”) generated using the same registration face image and feature vectors (referred to as “registration feature vectors”) for the registration face image, i.e., a single face image. The registration feature vectors and the third focused region map can be calculated by a method similar to that described above. Specifically, a method is of inputting a registration face image as a second image, performing face detection on the input second image to detect a face, calculating a feature vector (second feature vector) and a registration last intermediate map (second intermediate feature map) based on the detected face, and calculating a third focused region map using the calculated feature vector and the calculated registration last intermediate map. The storage unit 501 manages the person ID of the registered person, the registration feature vector for the person, and the third focused region map in association with one another.

The third focused region map is a focused region map calculated based on the same registration image (single registration image). Apparently from the foregoing description, a focused region map is a map showing the pixels (or a region as a set of pixels) focused in calculating the cosine similarity. Since the third focused region map is calculated in comparing the same registration image, the third focused region map is calculated from the registration image alone. Thus, the third focused region map is information that visualizes the region focused in recognizing an individual on the registration image.

The storage unit 501 transmits the stored pair of the registration feature vector and the person ID of the registered person to the recognition unit 104. Further, the storage unit 501 transmits the registration feature vector for the person to the generation unit 105 based on the recognition result (a result of determination of whether the input face image is of one or none of the person IDs of the registered persons) transmitted from the recognition unit 104. At that time, the storage unit 501 outputs the third focused region map for the person.

The generation unit 105 receives the last intermediate map (the first intermediate feature map) for the first image from the extraction unit 103 and receives the registration feature vector from the storage unit 501. The generation unit 105 calculates the first focused region map based on the received information. In a method of calculating a focused region map for the first image, a first focused region map for the first image is output using a last intermediate map (the first intermediate feature map) and a registration feature vector that are extracted from the first image.

Further, the generation unit 105 outputs the third focused region map that satisfies a predetermined condition. For example, a predetermined condition is set to acquire a map that corresponds to a registration feature vector with a feature vector similarity greater than a predetermined threshold value or the top ten (predetermined number) maps in decreasing order of similarities. The number of sets of registration feature vectors to be transmitted from the storage unit 501 to the generation unit 105 is predetermined. For example, nothing but the registration feature vector for the person ID of the registered person of the highest similarity through the calculation by the recognition unit 104 is transmitted. In this case, one focused region map is calculated. In addition, the storage unit 501 outputs the third focused region map that corresponds to the person ID of the registered person of the highest similarity. Further, if the focused region maps for all the registered persons as well as the person ID of the registered person of the highest similarity are used, the registration feature vectors for all the persons are transmitted to the generation unit 105. In this case, what are output by the storage unit 501 is the third focused region maps for the person IDs of all the registered persons. Comparing a plurality of focused region maps makes it easy to check the reliability of the recognition result and the accuracy of the trained model.

As described above, a face recognition system that compares an input face image with a registered face image outputs a focused region map in face recognition, clarifying a basis for determination in face recognition.

The focused region map calculated in the present exemplary embodiment is a focused region map calculated in comparing the third focused region map calculated from one registration image, the first image, and the registration image. The third focused region map is information that visualizes the regions focused in recognizing an individual on the registration image. By comparing the pattern of the third focused region map and the pattern of the focused region map calculated in comparing the input image and the registration image, the regions focused in face recognition to determine that two faces are of the same person can be understood. Presenting a basis for determination in face recognition using the focused region map as described above in the present exemplary embodiment is expected to gain reliability of the face recognition and clear an obstacle to practical use.

### OTHER EXEMPLARY EMBODIMENTS

The extraction unit 103 trained using a loss function calculated based on a focused region map can be used. This training increases recognition accuracy in face recognition using focused region maps. As described above in the exemplary embodiments, among focused region maps calculated using feature vectors and last intermediate maps calculated by the extraction unit 103 trained in advance, the focused region maps generated from a pair of the same person ID have a similar pattern to each other. The focused region maps generated from a pair of different person IDs have different patterns from each other. In the present exemplary embodiment, an example will be described of designing a loss function based on a focused region map and training the extraction unit 103 using the loss function to highlight the above characteristics of a focused region map. A loss function is used for the focused region maps generated from the same person ID to have a similar pattern to each other and for the focused region maps generated from different person IDs to have different patterns from each other. For example, the method discussed in Reference Document 1 (Reference Document 1: Dimensionality Reduction by Learning an Invariant Mapping, R. Hadsell, S. Chopra, Y. LeCuncvpr, 2006) can be used in which a contrastive loss function for focused region maps is designed as a loss function and is learned as a siamese network. The loss function discussed in Reference Document 1 compares feature vectors calculated based on two face images (a person ID is provided because the two face images are training images). The loss function is designed so that the loss increases as the distance between the feature vectors increases with the two face images of the same person ID whereas the loss increases as the distance between the feature vectors decreases with the two face images of different person IDs. Thus, training is performed so that the distance between both feature vectors decreases with two face images of the same person ID whereas the distance between both feature vectors increases with two face images of different person IDs. For example, a trained model is trained based on the loss function designed so that the focused region maps generated from two images of the same person are similar to each other whereas the focused region maps generated from two images of different persons are not similar to each other. Further, the contrastive loss can be combined with a loss function for conventional feature vectors, the combination of which is taken as a final loss function.

The above described training clearly provides a similar pattern in the focused region maps generated from a pair of the same person ID to each other and different patterns in the focused region maps generated from a pair of different person from each other. Thus, use of the characteristics of the focused region maps acquired by training allows an increase in face recognition accuracy.

### Exemplary Embodiment 1-1

In the first exemplary embodiment, the example has been described of performing pooling processing referred to as GAP on the last intermediate map 208 in the CNN used by the extraction unit 103 to calculate feature vectors.

In the present exemplary embodiment, an example will be described of performing full-connection processing, which is not GAP. Specifically, full-connection processing in the CNN used in the present exemplary embodiment is performed on a last intermediate map to calculate feature vectors.

Feature vectors are calculated through GAP described in the first exemplary embodiment with the number of dimensions of the last intermediate map in the channel direction equal to the number of dimensions of feature vectors. On the other hand, feature vectors are calculated by full-connection processing with no particular limitation of the relation between the number of dimensions of the last intermediate map in the channel direction and the number of dimensions of feature vectors. This allows the appropriate number of dimensions of feature vectors to be selected in designing the CNN. The number of dimensions of feature vectors significantly affects the accuracy of an application (e.g., face recognition) that uses the feature vectors and the processing time, which means that an appropriate selection in designing a network is beneficial to use of full-connection processing.

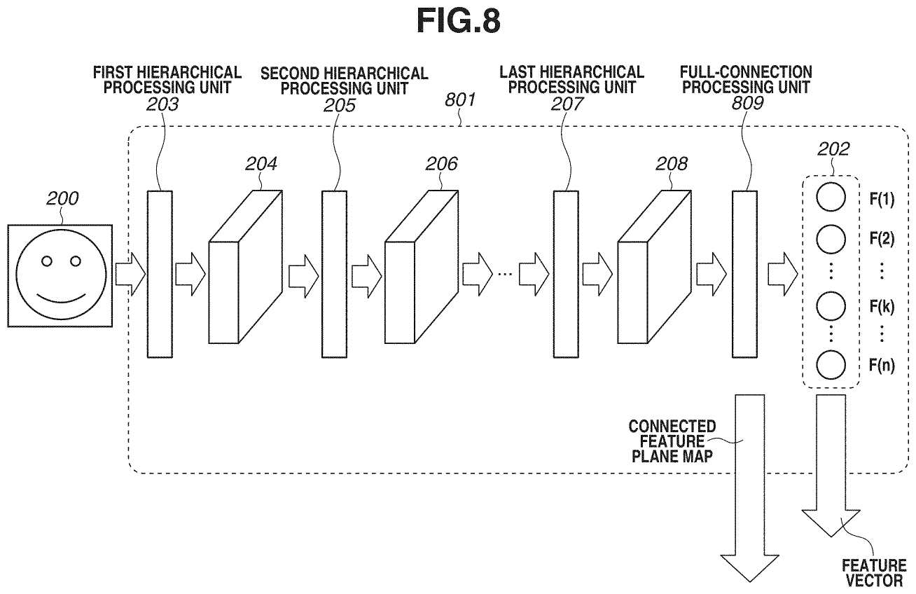

FIG. 8 is a schematic diagram illustrating a process in the extraction unit 103 according to the present exemplary embodiment. In FIG. 8, like numbers refer to like components in FIG. 2, and redundant descriptions thereof will be omitted. An extraction unit 801 and a full-connection processing unit 809 are shown in FIG. 8. The full-connection processing unit 809 performs matrix multiplication on one-dimensionally arrayed data constituting the last intermediate map 208 to calculate feature vectors.

The processing of re-arraying a multi-dimensional array such as an intermediate map into one-dimensional vectors is referred to as “flattening processing” in general. For example, when the last intermediate map 208 is a 7×7×512 array (vertical size×horizontal size×channel-direction size), a one-dimensional vector acquired by flattening processing is a 25088 (=7×7×512) dimensional vector.

Further, a matrix multiplied by a one-dimensional vector obtained by flattening processing is referred to as “full-connection weight matrix”. A feature vector is obtained by the matrix multiplication of a one-dimensional vector obtained by flattening and a full-connection weight matrix. For example, through the matrix multiplication of a one-dimensional vector in 25088 dimensions as described above and a 25088×512 full-connection weight matrix, a feature vector in 512 dimensions is obtained. As described above, any size in the horizontal direction is applicable to a full-connection weight matrix. For example, with a 25088×256 full-connection weight matrix, a feature vector in 256 dimensions is obtained.

As with the first exemplary embodiment, the element value of the position (x, y) of the kth feature plane of the last intermediate map 208 is denoted by f(x, y, k). The size of the last intermediate map is s×t×n (1≤x≤s, 1≤y≤t, 1≤k≤n). Further, a calculated feature vector is denoted by F, and the jth element of the calculated feature vector is denoted by F(j). The size of a feature vector is denoted by u (1≤j≤u). Consequently, the size of the full-connection weight matrix is (s×t×n)×u.

In this case, the last intermediate map is expressed as

$$[ \begin{matrix}f ( 1 , 1 , 1 ) , f ( 1 , 2 , 1 ) , … , f ( 1 , t , 1 ) \\ f ( 2 , {1}_{′} 1 ) , f ( 2 , 2 , 1 ) , … , f ( 2 , t , 1 ) \\ … \\ f ( s , 1 , 1 ) , f ( s , 2 , 1 ) , … , f ( s , t , 1 )\end{matrix} ] , \\ [ \begin{matrix}f ( 1 , 1 , n ) , f ( 1 , 2 , n ) , … , f ( 1 , t , n ) \\ f ( 2 , {1}_{′} n ) , f ( 2 , 2 , n ) , … , f ( 2 , t , n ) \\ … \\ f ( s , 1 , n ) , f ( s , 2 , n ) , … , f ( s , t , n )\end{matrix} ] .$$

Further, the one-dimensional vector obtained by flattening the last intermediate map is [f(1,1,1), f(1,2,1), . . . , f(s, t,1), f(1,1,2), . . . , f(s,t,2), f(1,1,3), . . . , f(s,t,n)]. Further, the elements of the full-connection weight matrix are expressed as W(x, y, k, j) as follows. The full-connection weight matrix is a two-dimensional matrix, but for a simple description, the full-connection weight matrix is expressed as being indexed by four variable numbers.

$$[ \begin{matrix}W ( 1 , 1 , 1 , 1 ) , W ( 1 , 1 , 1 , 2 ) , … , W ( 1 , 1 , 1 , u ) \\ W ( 1 , 2 , 1 , 1 ) , W ( 1 , 2 , 1 , 2 ) , … , W ( 1 , 2 , 1 , u ) \\ … \\ W ( s , t , 1 , 1 ) , W ( s , t , 1 , 2 ) , … , W ( s , t , 1 , u ) \\ W ( 1 , 1 , 2 , 1 ) , W ( 1 , 1 , 2 , 2 ) , … , W ( 1 , 1 , 2 , u ) \\ W ( 1 , 2 , 2 , 1 ) , W ( 1 , 2 , 2 , 2 ) , … , W ( 1 , 2 , 2 , u ) \\ … \\ W ( s , t , 2 , 1 ) , W ( s , t , 2 , 2 ) , … , W ( s , t , 2 , u ) \\ W ( 1 , 1 , 3 , 1 ) , W ( 1 , 1 , 3 , 2 ) , … , W ( 1 , 1 , 3 , u ) \\ W ( 1 , 2 , 3 , 1 ) , W ( 1 , 2 , 3 , 2 ) , … , W ( 1 , 2 , 3 , u ) \\ … \\ W ( s , t , n , 1 ) , W ( s , t , n , 2 ) , … , W ( s , t , n , u )\end{matrix} ]$$

A feature vector is calculated by the matrix multiplication of a one-dimensional vector obtained by flattening and a full-connection weight matrix. Specifically, a feature vector is calculated by

$$F ( j ) = {\sum }_{x} {\sum }_{y} {\sum }_{k} f ( x , y , k ) \times W ( x , y , k , j ) = {\sum }_{x} {\sum }_{y} h ( x , y , j ) , \\ h ( x , y , j ) = {\sum }_{k} f ( x , y , k ) \times W ( x , y , k , j ) .$$

The data h(x, y, j) calculated as intermediate data in feature vector calculation will be referred to as “connected feature plane map”. The extraction unit 801 outputs a calculated connected feature plane map h(x, y, j) and a calculated feature vector F(j).

The generation unit 105 according to the first exemplary embodiment calculates a focused region map G(x, y) based on a last intermediate map f and a feature vector F output from the extraction unit 103. In the present exemplary embodiment, a focused region map G(x, y) is calculated based on a connected feature plane map h and a feature vector F calculated by the extraction unit 801. The calculation is performed using a method similar to that in the first exemplary embodiment, so that redundant descriptions thereof will be omitted.

As described in detail above, a focused region map is calculated even with full-connection processing on the last layer in the processing performed by the extraction unit 103.

For a simple description, full-connection processing without a bias term has been described above. Apparently, the present disclosure is also applicable to full-connection processing with a bias term. In this case, a bias term is added to a connected feature plane map h. Let B(j) denote a bias term for each j, specifically, a numerical value obtained by dividing a bias term B(j) for each j by s×t is added to each pixel of a connected feature plane map h. The connected feature plane map h with the bias term added is output as a connected feature plane map.

Similarly, with batch normalization processing following the full-connection processing, a connected feature plane map h including parameters for use in batch normalization processing is output as a connected feature plane map.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Applications No. 2020-161333, filed Sep. 25, 2020, and No. 2021-090733, filed May 31, 2021, which are hereby incorporated by reference herein in their entirety.

What is claimed is:

1. An information processing apparatus configured to determine whether a person in one of two images and a person in the other image are the same person by using a trained model configured to output a feature unique to each person on an image, the information processing apparatus comprising:
an acquisition unit configured to acquire a first feature of a first person in a first image and a second feature of a second person in a second image by using the trained model; and
an output unit configured to output a first focused region map indicating a correlation between a feature in the first image and a feature in the second image for each region of the first image based on the acquired first feature and the acquired second feature.

2. The information processing apparatus according to claim 1,
wherein the acquisition unit acquires a first intermediate feature map as the first feature and acquires a second feature vector as the second feature, and
wherein the output unit outputs the first focused region map based on a correlation of the second feature vector with the first intermediate feature map.

3. The information processing apparatus according to claim 2, further comprising a storage unit configured to store, as the second feature vector, a feature vector corresponding to a pre-registered face image,
wherein the output unit outputs the first focused region map based on the first intermediate feature map and the stored second feature vector.

4. The information processing apparatus according to claim 1,
wherein the acquisition unit acquires a first feature vector as the first feature and acquires a second intermediate feature map as the second feature, and
wherein the output unit outputs a second focused region map indicating a correlation between a feature in the first image and a feature in the second image for each region of the second image based on a correlation of the first feature vector with the second intermediate feature map.

5. The information processing apparatus according to claim 1, further comprising a determination unit configured to determine whether a person in the first image and a person in the second image are the same person based on the acquired first feature and the acquired second feature.

6. The information processing apparatus according to claim 5, wherein the determination unit determines whether an object in the first image and an object in the second image are the same object based on a second focused region map indicating a correlation between a feature in the first image and a feature in the second image for each region of the second image, and on the first focused region map.

7. The information processing apparatus according to claim 6,
wherein the storage unit further stores a third focused region map output based on a pre-registered face image and the trained model, and
wherein the output unit outputs the third focused region map that satisfies a predetermined condition.

8. The information processing apparatus according to claim 1, further comprising:
a reception unit configured to receive feedback information from a user, the feedback information indicating whether the first person and the second person are the same person; and
an updating unit configured to update a parameter of the trained model based on the received feedback information.

9. The information processing apparatus according to claim 1, wherein the trained model is trained based on a loss function designed so that a focused region map generated from an image of a person and a focused region map generated from another image of the same person are similar to each other whereas a focused region map generated from an image of a person and a focused region map generated from an image of a different person are not similar to each other.

10. The information processing apparatus according to claim 1, further comprising a display unit configured to display the first focused region map output by the output unit.

11. The information processing apparatus according to claim 1,
wherein the acquisition unit acquires a first intermediate feature map and a first feature vector as the first feature, and
wherein the first feature vector is obtained by performing global average pooling processing on the first intermediate feature map.

12. The information processing apparatus according to claim 1,
wherein the acquisition unit acquires a first intermediate feature map and a first feature vector as the first feature, and
wherein the first feature vector is obtained by performing full-connection processing on the first intermediate feature map.

13. An information processing method of determining whether a person in one of two images and a person in the other image are the same person by using a trained model configured to output a feature unique to each person on an image, the method comprising:
acquiring a first feature of a first person in a first image and a second feature of a second person in a second image by using the trained model; and
outputting a first focused region map indicating a correlation between a feature in the first image and a feature in the second image for each region of the first image based on the acquired first feature and the acquired second feature.

14. A non-transitory computer-readable storage medium storing a program for causing a computer to execute an information processing method of determining whether a person in one of two images and a person in the other image are the same person by using a trained model configured to output a feature unique to each person on an image, the method comprising:
acquiring a first feature of a first person in a first image and a second feature of a second person in a second image by using the trained model; and
outputting a first focused region map indicating a correlation between a feature in the first image and a feature in the second image for each region of the first image based on the acquired first feature and the acquired second feature.
